(19) United States
(12) Patent Application Publication
(10) Pub. No.: US 2016/0266005 A1
(43) Pub. Date: Sep. 15, 2016

(54) METHODS AND APPARATUS FOR SIMULTANEOUS OPTICAL PARAMETER MEASUREMENTS

(71) Applicant: INTUITIVE SURGICAL OPERATIONS INC., Sunnyvale, CA (US)

(72) Inventor: Joseph J. BOS, Christiansburg, VA (US)

(21) Appl. No.: 14/778,333

(22) PCT Filed: Mar. 18, 2014
(86) PCT No.: PCT/US2014/030976

§ 371 Date: Sep. 18, 2015

Related U.S. Application Data
(60) Provisional application No. 61/803,181, filed on Mar. 19, 2013.

(51) Int. Cl. G01M 11/00

(52) U.S. Cl. CPC G01M 11/331

(57) ABSTRACT

Example apparatus and methods for performing measurements on an optical device are described for characterizing the optical device. An interrogating laser light source generates light at multiple different wavelengths during a single sweep of the laser light source. One or more optical interferometric interrogators are connected to the interrogating laser light source and connectable to the optical device such that light from the laser is coupled to the optical device and light from the optical device is received by the one or more optical interferometric interrogators in multiple different directions along a number of optical interferometric measurement paths. Optical detection circuitry detects an optical interference pattern, for each of the number of optical interferometric light paths, generated during the single sweep of the interrogating laser light source. Data processing circuitry determines one or more optical parameters associated with a response determined for each of the number of optical interferometric light paths based on the optical interference pattern detected for each of the number of optical interferometric light paths generated during the single sweep of the interrogating laser.

### PRIORITY APPLICATION

Priority is claimed from U.S. provisional patent application 61/803,181, filed on Mar. 19, 2013, the contents of which are incorporated herein by reference.

### TECHNICAL FIELD

The technology in this application relates to optical measurement apparatus and techniques.

### BACKGROUND

Optical devices are used in optical networks for telecommunications, sensing, and many other applications to direct signals from one location to another. The devices used to construct such networks span a variety of technologies and topologies. For example, a coupler or beam splitter may be used to separate a given signal according to a particular power ratio or polarization orientation. Another networking element called a wavelength selectable switch (or WSS) is used to split or combine signals according to optical frequency. Couplers and WSSs are examples of M×N port devices, where M represents the number of input ports and N represents the number of output ports. Further, these devices are often used to transmit and reflect light with particular characteristics from some combination of input ports to another specific combination of output ports. This means that there are multiple light paths in an optical device, some of which will have different directions. It is therefore desirable for an optical measurement instrument or technique for characterizing optical devices to be capable of measuring many or all permutations of light paths through an optical device with reduced or no user-interaction, time, and cost.

Ideally, an optical device under test (DUT) should be fully characterized after a single data acquisition, e.g., a single laser sweep in an optical interrogation system. Depending on the nature of the optical device, e.g., a 1×1 isolator, a 3×3 coupler, a 36×36 wavelength-selectable switch, etc., full characterization may include one or more optical device characterizing parameters, such as insertion loss (IL), phase, group delay (GD), chromatic dispersion (CD), polarization mode dispersion (PMD), second order polarization mode dispersion (SOPMD), differential group delay (DGD), polarization dependent loss (PDL), etc., in one or multiple directions through a device, through one or several permutations of paths through the device, including transmission and/or reflection paths.

Ziegler et al. (U.S. Pat. No. 7,268,342) discloses a method which allows characterization of a single device in two directions simultaneously in a transmission path and a reflection path. However, this requires additional modulators and optical receivers for each signal which increases signal error, cost, and complexity. Multiple measurements are required at each wavelength step to obtain PDL and PMD, and as a consequence, optical phase information is lost, even though GD is retained. Characterization of multiple port devices, such as I×N or M×N devices, is not addressed.

Froggatt et al. (U.S. Pat. No. 6,376,830) discloses a method for measuring the transfer function of a single N-port guided wave device. Although this technology provides access to IL, phase, GD, CD, PMD, DGD, PDL, it requires N reference path lengths, N measurement path lengths, and N optical receivers, which increases hardware cost and complexity in design, build, and calibration. More recent work from Froggatt et al. (U.S. Pat. No. 7,042,573) addresses characterization of 1×N port devices (N=2 or more) and multiple 1×1 port devices in one direction and in either transmission or reflection, but not both simultaneously. Further, this work does not address characterization of multiple port devices (i.e., M×N devices where both M and N=2 or more).

### SUMMARY

An example apparatus and method for performing measurements on an optical device to characterize the optical device includes an interrogating laser light source that generates light at multiple different wavelengths during a single sweep of the laser light source. One or more optical interferometric interrogators are connected to the interrogating laser light source and connectable to the optical device such that light from the laser is coupled to the optical device and light from the optical device is received by the one or more optical interferometric interrogators in multiple different directions along a number of optical interferometric measurement paths. Optical detection circuitry detects an optical interference pattern, for each of the number of optical interferometric light paths, generated during the single sweep of the interrogating laser light source. Data processing circuitry determines one or more optical parameters associated with a response determined for each of the number of optical interferometric light paths based on the optical interference pattern detected for each of the number of optical interferometric light paths generated during the single sweep of the interrogating laser.

In different example embodiments, the number is one or greater than one.

Preferably, delays associated with the one or more optical interferometric light paths are selected so that each interference pattern is detected at a unique detection bandwidth.

In example embodiments, the optical detection circuitry includes one set of optical detectors configured to detect the optical interference patterns for each of the optical interferometric light paths generated during the single sweep of the interrogating laser light source. The one set of optical detectors detects, using a first portion of available detection bandwidth, the optical interference patterns for optical interferometric light transmission paths generated during the single sweep of the interrogating laser light source, and detects, using a second different portion of the available detection bandwidth, the optical interference patterns for optical interferometric light reflection paths generated during the single sweep of the interrogating laser light source.

In other example embodiments, the optical detection circuitry includes multiple sets of optical detectors configured to detect the optical interference patterns for each of the optical interferometric light paths generated during the single sweep of the interrogating laser light source. Each of the multiple sets of optical detectors detects, using an available detection bandwidth, the optical interference patterns for optical interferometric light transmission paths generated during the single sweep of the interrogating laser light source, and detects, using substantially the same available detection bandwidth, the optical interference patterns for optical interferometric light reflection paths generated during the single sweep of the interrogating laser light source.

In yet other example embodiments, the one or more optical interferometric interrogators include a measurement optical interferometric interrogator and a laser monitor optical interferometric interrogator. The one or more optical interferometric interrogators may include another optical interferometric interrogator that includes a polarization controller that provides light with orthogonal polarization states for probing the optical device.

Example optical parameters include one or more of insertion loss (IL), phase, group delay (GD), chromatic dispersion (CD), polarization mode dispersion (PMD), second order polarization mode dispersion (SOPMD), differential group delay (DGD), or polarization dependent loss (PDL). The determined one or more optical parameters may fully optically characterize the optical device through all light propagation paths including all permutations of optical device input ports and optical device output ports.

An example method for performing measurements on an optical device includes:

generating, during a single sweep of a laser light source, light at multiple different wavelengths;

guiding light from the laser, via one or more optical interferometric interrogators, to the optical device in multiple different directions along a number of optical interferometric measurement paths;

receiving light from the optical device in multiple different directions along the number of optical interferometric measurement paths by the one or more optical interferometric interrogators;

detect an optical interference pattern, for each of the number of optical interferometric light paths, generated during the single sweep of the interrogating laser light source; and

determining one or more optical parameters associated with a response determined for each of the number of optical interferometric light paths based on the optical interference pattern detected for each of the number of optical interferometric light paths generated during the single sweep of the interrogating laser.

In example method embodiments, the method further comprises determining a maximum number of optical paths through the optical device including transmission paths, reflection paths, permutations of light coupling from input to input ports, input to output ports, output to input ports, and output to output ports; determining a minimum number of reference paths for the one or more optical interferometric interrogators; and determining optical path lengths that provide delay domain separation for each optical path through the optical device as compared with reference path optical delays and available detection bandwidth.

### BRIEF DESCRIPTION OF THE DRAWINGS

FIGS. 1A and 1B depict an example of a reflection (Rx) OFDR measurement system;

FIGS. 2A and 2B depict an example of a transmission (Tx) OFDR measurement system;

FIG. 3 shows an example laser monitor interferometer network for monitoring magnitude and direction of phase changes throughout a tunable laser sweep;

FIG. 4 is a flowchart diagram illustrating example OFDR operation;

FIG. 5 is a non-limiting example OFDR apparatus for optical characterization of an optical device through permutations of input to output ports including transmission and reflection characterization from multiple directions;

FIG. 6 is a flowchart diagram illustrating non-limiting example steps for characterizing an optical device in a single laser sweep;

FIGS. 7-12 shown non-limiting example OFDR measurement networks that provide simultaneous Tx and Rx OFDR measurements of an optical DUT;

FIG. 13 shows an non-limiting example network that enables simultaneous, single sweep, bidirectional loss and phase measurements of an optical device;

FIG. 14 shows a non-limiting example 1×N measurement network that measures all transmission paths of the device using one polarization diverse receiver;

FIG. 15 is non-limiting example network that enables simultaneous measurement of all ports of M×N devices in a single laser sweep; and

FIG. 16 is plot of the detected measurement responses for the non-limiting example network in FIG. 15.

### DETAILED DESCRIPTION

The following description sets forth specific details, such as particular embodiments for purposes of explanation and not limitation. But it will be appreciated by one skilled in the art that other embodiments may be employed apart from these specific details. In some instances, detailed descriptions of well known methods, nodes, interfaces, circuits, and devices are omitted so as not obscure the description with unnecessary detail. Those skilled in the art will appreciate that the functions described may be implemented in one or more nodes using optical components, electronic components, hardware circuitry (e.g., analog and/or discrete logic gates interconnected to perform a specialized function, ASICs, PLAs, etc.), and/or using software programs and data in conjunction with one or more digital microprocessors or general purpose computers. Moreover, certain aspects of the technology may additionally be considered to be embodied entirely within any form of computer-readable memory, such as solid-state memory, magnetic disk, or optical disk containing an appropriate set of computer instructions that would cause a processor to carry out the techniques described herein.

Hardware implementations of certain aspects of the technology may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

After a connection of an optical device's input and output ports to an optical interrogation system, only a single sweep of a tunable laser in that optical interrogation system is needed to characterize the device through all propagation paths, including in transmission and/or reflection in all directions and including all permutations of input ports to output ports, effectively minimizing user-interaction, measurement time, and the cost of characterization equipment. The technology may be used to fully characterize optical devices with single or multiple input ports and single or multiple output ports, e.g., 1×N or M×N port configurations. Non-limiting example optical networks provide simultaneous bidirectional transmission measurements of loss and phase (and its derivatives) in a single laser sweep. Other example embodiments in a single laser sweep provide simultaneous bidirectional transmission measurements of a device's linear transfer function from which all linear parameters may be calculated such as insertion loss (IL), phase, group delay (GD), chromatic dispersion (CD), polarization mode dispersion (PMD), second order polarization mode dispersion (SOPMD), differential group delay (DGD), polarization dependent loss (PDL), etc. Since only a single laser sweep is needed, the technology minimizes the time required to provide full characterization of all parameters in all directions, in transmission and reflection.

Additional advantageous features of the technology include a relatively simple and inexpensive way to characterize optical devices by minimizing the number of reference paths used (often one single reference path is sufficient) to interfere with all permutations of measurement paths through a device. Each optical measurement path associated with the optical device is assigned a particular optical delay, the result of which is delay separation upon Fourier transform of the superposed interferograms. For simplicity, optical paths are often referred to simply as paths.

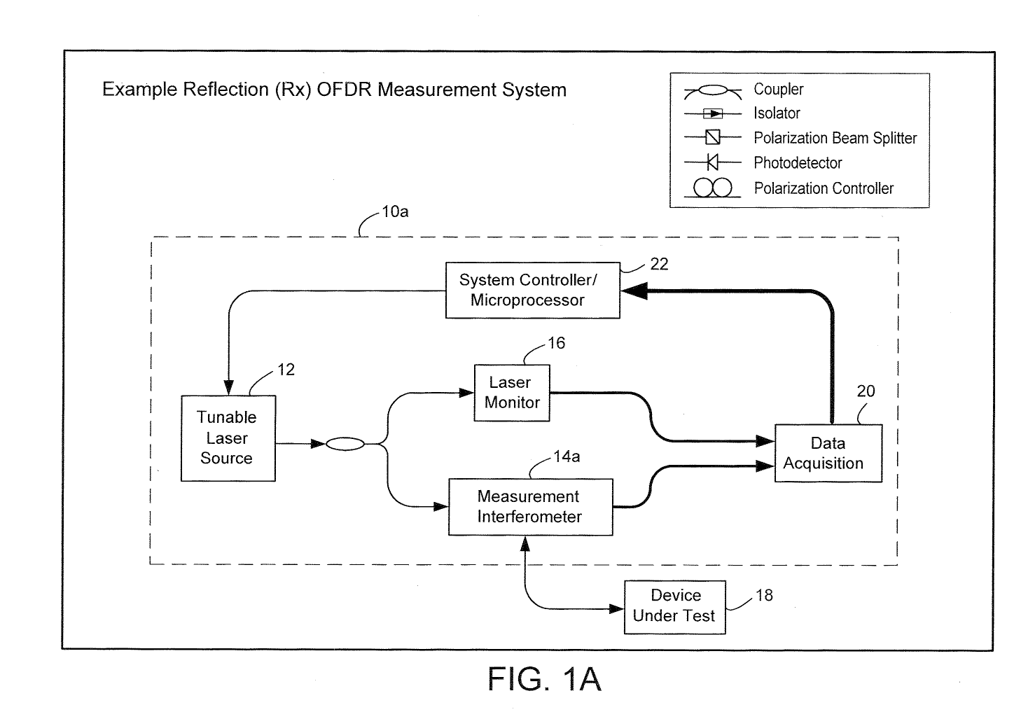

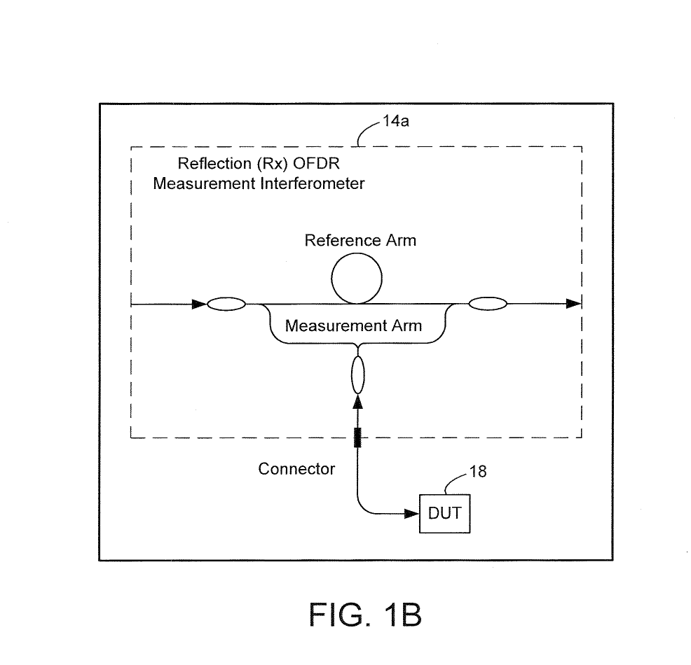

The following provides some background on optical frequency domain reflectometry (OFDR). Referring to FIG. 1A, an example reflection OFDR system 10a is depicted which includes a tunable light source 12, an optical network that includes a measurement interferometer 14a and possibly a laser monitor interferometer 16, an electronic detection and data acquisition system 20, a system controller 22 having one or more microprocessors. The system controller 22 initiates the sweep of the tunable laser 12 source over an optical frequency range, e.g., multiple different light wavelengths. The light is split between the laser monitor interferometer 16 and the measurement interferometer 14a. Arrows indicate the direction of light propagation. The laser monitor interferometer 16 includes an absolute wavelength reference and a relative phase monitor.

FIG. 1B shows further details for the example embodiment of a reflection (Rx) OFDR instrument 10a. The light input to the measurement interferometer 14a is split between a reference path or arm and a measurement path or arm that is connected via connector to an optical device under test (DUT) 18. Reflected light from the DUT 18 comes back through the same path and connector used to inject light into the DUT 18.

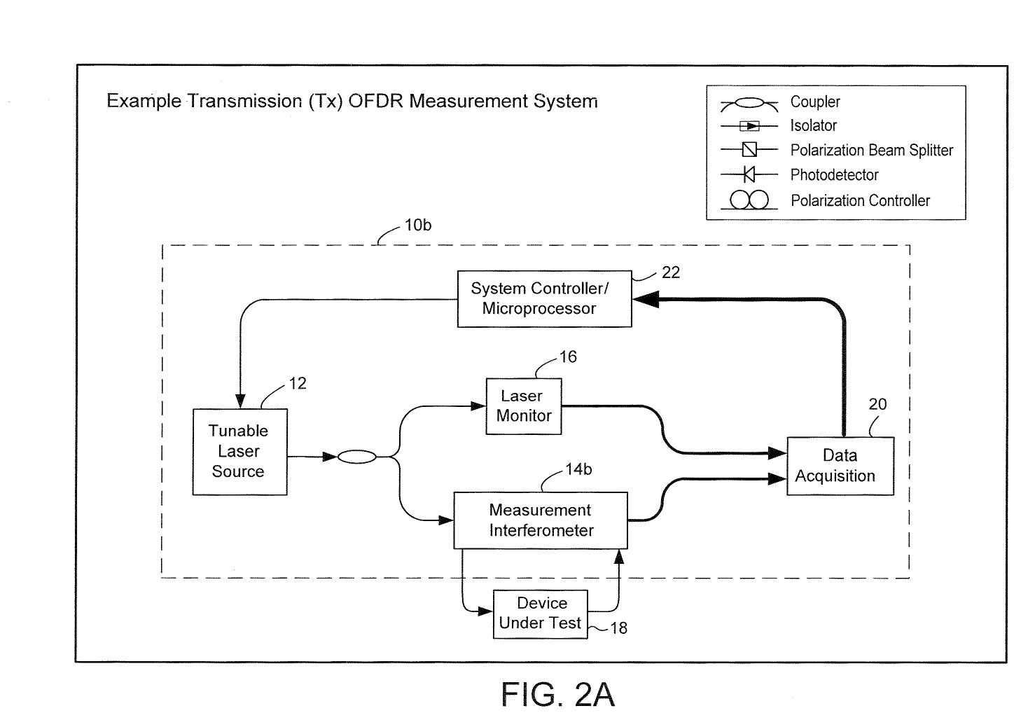

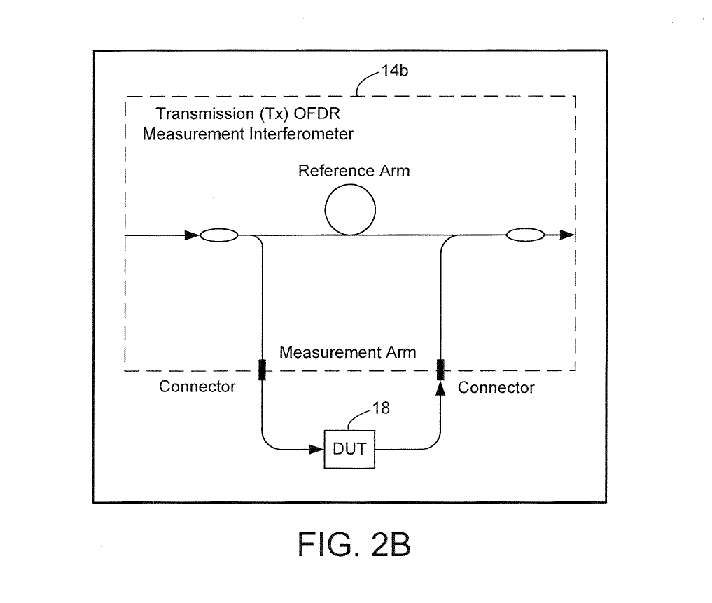

FIG. 2A shows an example embodiment of a transmission (Tx) OFDR instrument 10b which is similar to the OFDR 10a except with respect to how the DUT 18 is connected to the OFDR system as can be seen by a comparison of FIGS. 1A and 2A. FIG. 2B shows further details of the transmission (Tx) OFDR instrument 10b where light input to the measurement interferometer 14b is split between a reference path (called an arm in the figure) and the DUT input port via a first connector, and the light comes back into the measurement interferometer 14b through a DUT output port via a second connector.

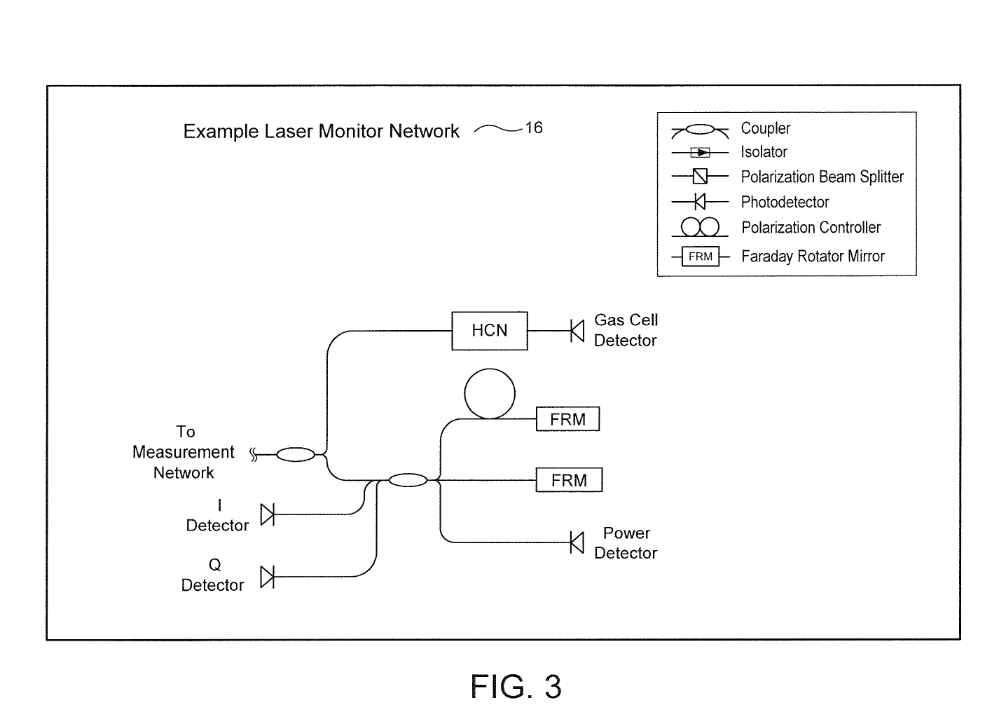

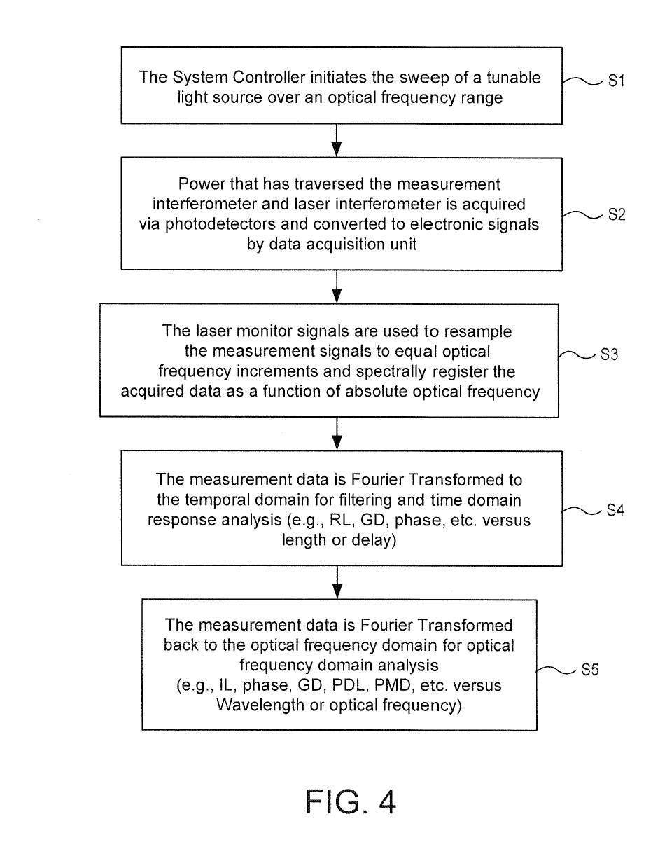

An example laser monitor interferometer network 16 is shown in FIG. 3 for monitoring magnitude and direction of phase changes throughout laser sweep. The laser monitor interferometer network 16 includes an absolute wavelength or optical phase reference and relative wavelength or optical phase reference. This example embodiment uses a gas cell for absolute wavelength reference and a fiber optic interferometer for relative phase measurement. Gas cells have well-documented absorption spectra which provide absolute wavelength information. Fiber optic interferometers can be constructed to provide both the magnitude and direction of phase changes with very high precision (see U.S. Pat. No. 6,426,496 incorporated herein by reference). The relative phase monitor interferometer is used since there are portions of the OFDR sweep that may potentially not cross a gas cell absorption line. Further, precise wavelength information is required for optical frequency linearization of the acquired interferogram prior to Fourier Transform operation (described below in FIG. 4) as well as for spectral accuracy in wavelength dependent measurements.

FIG. 4 is a flowchart diagram illustrating example OFDR operation. In both Rx and Tx OFDR measurements, the system controller initiates the sweep of a tunable laser light source over an optical frequency (or wavelength) range (step S1). Light (or power) that has traversed the measurement interferometer and the laser monitor interferometer is detected via photodetectors and converted to electronic signals by the data acquisition unit (step S2). The signals from the laser monitor interferometer are used to resample the measurement interferometer signals to equal optical frequency increments and spectrally register the acquired measurement data as a function of absolute optical frequency (step S3). The resampled data is Fourier Transformed to the temporal domain for filtering and time domain response analysis (step S4) to determine measurement data, e.g., return loss (RL), group delay (GD), birefringence, beat length, polarization extinction ratio (PER), and optical phase versus delay down the device or construction of the device Jones Matrix. The measurement data may then be Fourier Transformed back to the optical frequency domain for optical frequency domain analysis (step S5). For example, the following may be calculated: IL, phase, GD, CD, PDL, differential group delay (DGD), PMD, SOPMD, etc., as a function of optical frequency or wavelength.

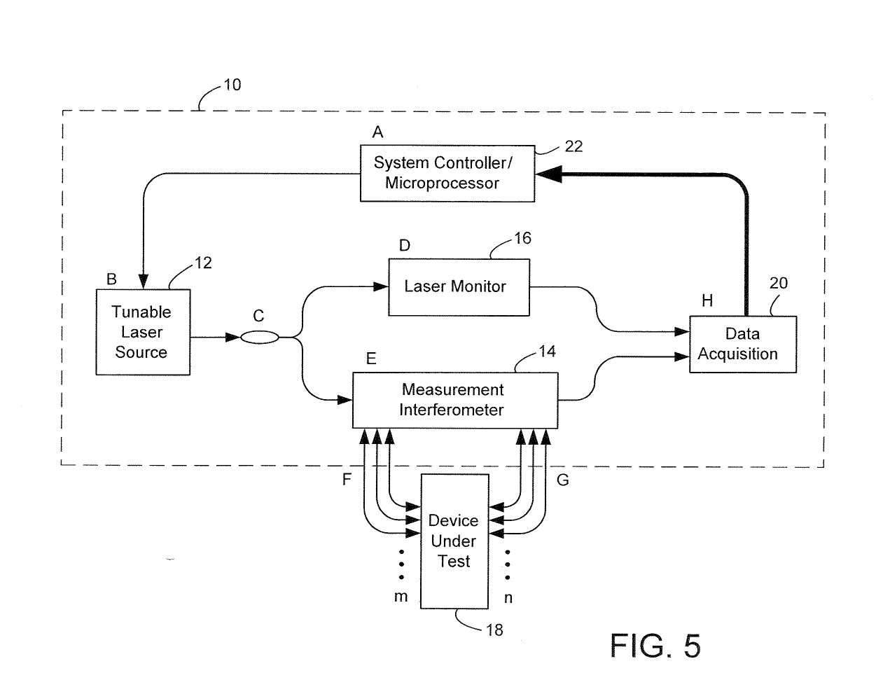

FIG. 5 is a non-limiting example OFDR apparatus for optical characterization of an optical device through permutations of input to output ports including transmission and reflection characterization from multiple directions. The letters m and n represent the number of input and output ports, respectively. The system controller (A) initiates the sweep of a tunable laser source over an optical frequency range. At the input coupler (C), the light is split between the laser monitor optics (D) and the measurement interferometer optics (E). The light input to the measurement interferometer (E) is split between a reference path and one or multiple paths through the device under test (DUT) including transmission and reflection paths from all directions. The difference between the time of flight of light that travels the DUT path light and the time of flight that travels the reference path is the “optical delay” or “path length” of the DUT.

Reflected light from the DUT returns to the measurement interferometer (E) via the same paths used to inject light into the DUT. That is, reflected light that is injected into the DUT through input fibers (F) returns to the measurement interferometer (E) through input fibers (F) and reflected light that is injected into the DUT through output fibers (G) returns to the measurement interferometer (E) through output fibers (G). Transmitted light through the DUT returns to the measurement interferometer (E) through the opposite fibers used to inject light into the DUT. That is, transmitted light that is injected into the DUT through input fibers (F) returns to the measurement interferometer through output fibers (G) and transmitted light that is injected into the DUT through the output fibers (G) returns to the measurement interferometer through input fibers (F). The light from the reference path and all permutations of measurement paths is interfered and the interferogram is detected by one or more photo-sensitive detectors in the data acquisition unit 20. The interferograms are converted to electronic signals, and the signals from the laser monitor D are used to resample the measurement signals to equal optical frequency increments and spectrally register the acquired data as a function of absolute optical frequency. The resampled data is Fourier Transformed to the temporal domain for filtering and time domain response analysis. By choosing the difference in the optical delays between each measurement path and the reference path to be unique, the optical response corresponding to each unique path can be extracted and analyzed.

Several non-limiting, example optical measurement interferometer networks will be described that illustrate an example design approach for constructing OFDR systems that enable measurement of one or more optical parameters of an optical device under test simultaneously in a single laser sweep. These non-limiting example embodiments can fully characterize a multiple port optical device in all directions, in transmission and reflection directions, and through all permutations of optical paths through the DUT via input to output ports. First, a maximum number of optical paths, Z, is determined through the device including transmission paths, reflection paths, permutations of light coupling from a) input to input ports, b) input to output ports, c) output to input ports, and d) output to output ports. Second, a minimum number of measurement interferometer reference paths are determined. Most often, using one or two measurement interferometer reference paths is sufficient and reduces the number of optical elements. Third, Z optical path lengths are determined that provide adequate delay domain separation for each optical path through the device as compared with the reference path optical delays and available detection bandwidth.

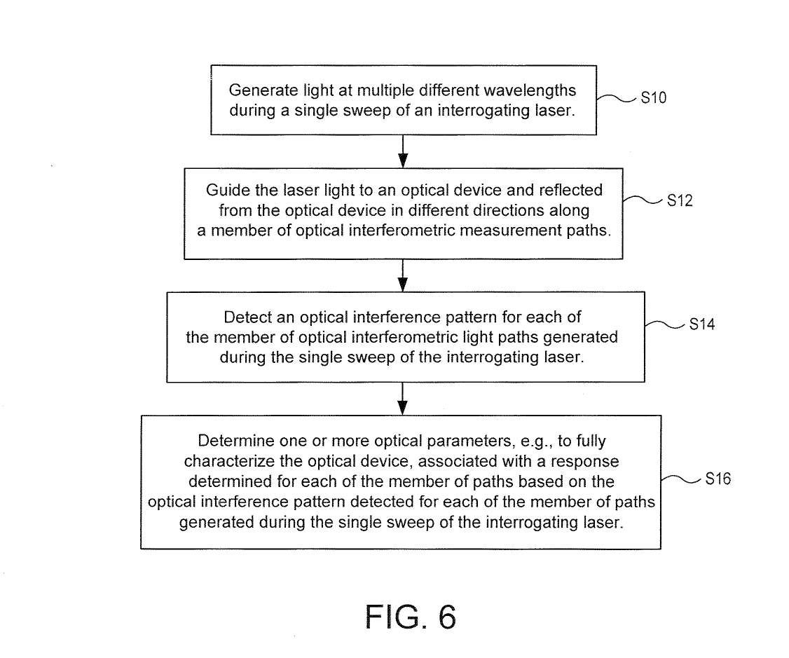

FIG. 6 is a flowchart diagram illustrating non-limiting example steps for characterizing an optical device in a single laser sweep. Step S10 includes generating, during a single sweep of a laser light source, light at multiple different wavelengths. Step S12 includes guiding light from the laser, via one or more optical interferometric interrogators, to the optical device and from the optical device in multiple different directions along a number of optical interferometric measurement paths. Then, step 14 detects an optical interference pattern, for each of the number of optical interferometric light paths, generated during the single sweep of the interrogating laser light source. One or more optical parameters associated with a response determined for each of the number of optical interferometric light paths are determined based on the optical interference pattern detected for each of the number of optical interferometric light paths generated during the single sweep of the interrogating laser in step S16.

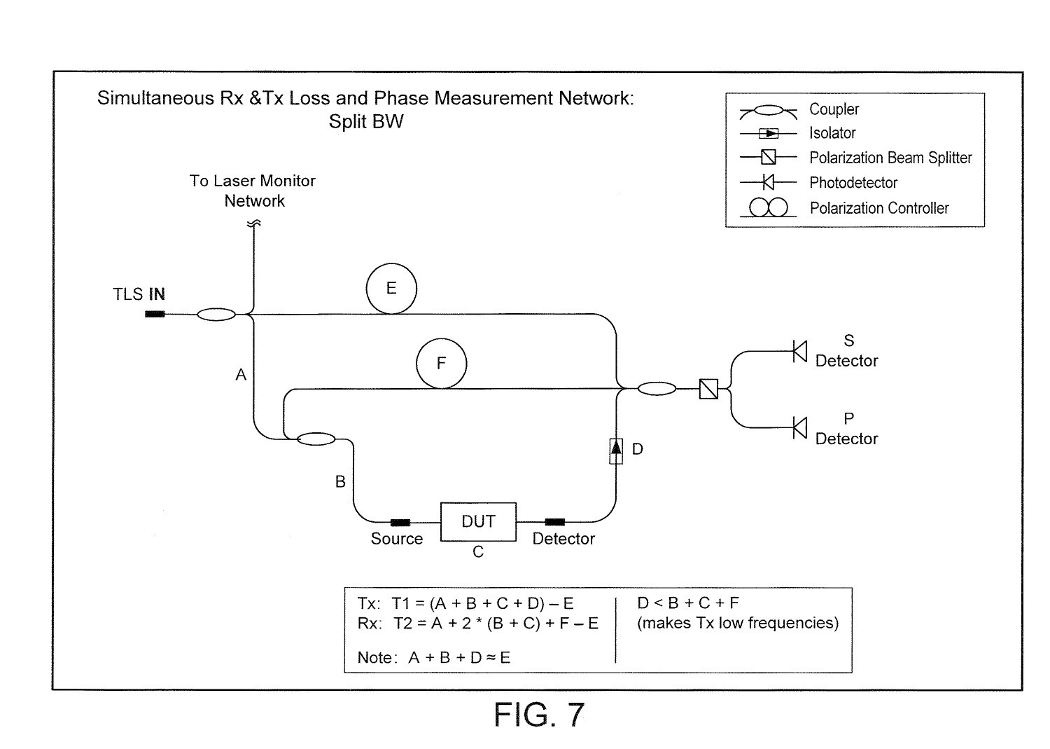

FIGS. 7-12 show non-limiting example embodiments of OFDR measurement networks that provide simultaneous Tx and Rx OFDR measurements of an optical DUT.

FIG. 7 is an example OFDR system that simultaneously measures IL, GD, CD in transmission and RL, GD, CD in reflection as a function of wavelength in a single laser sweep using a single polarization diverse receiver. The optical detection bandwidth is divided or multiplexed between the transmission and reflection signals by determining specific optical delays in the measurement interferometers. This is subsequently referred to as delay division multiplexing. In the example shown in FIG. 7, the transmission signal is contained in the interference signal resulting from the path difference between path ABCD (transmission through the device under test (DUT)) and path E, the reference path. The reflection signal is contained in the interference between path ABCCBF (reflection through the device) and path E, the reference path. Path F is part of the reflection path. In this embodiment, both the Rx and Tx signals use the same reference path and optical detectors (shown as the S and P detectors). By choosing the sum of path lengths A, B, and D approximately equal to reference path length E, the transmission interference signal is contained in a lower part of the available signal detection frequency band. Choosing lengths B, C and F such that their sum is greater than path length D, the reflection interference signal is contained in a higher part of the available signal detection frequency band.

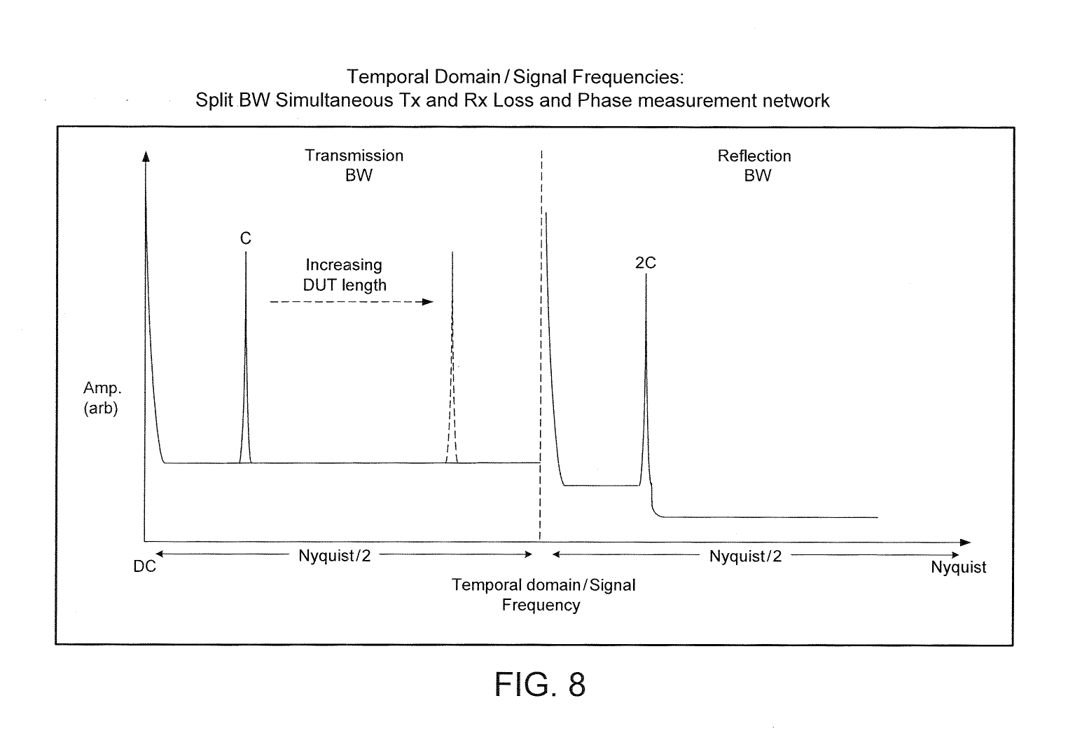

FIG. 8 is a plot for an example delay division multiplexed embodiment according to the system in FIG. 7 where the Rx and Tx signals each occupy half of the available detection bandwidth. However, different bandwidths may be allocated to the Rx and Tx signals by determining the optical path lengths A, B, C, D, E, and F accordingly, as described in the previous paragraph. The optical isolator shown in FIG. 7, though not strictly required, ensures that the detection optics do not appear in the reflection measurement data illustrated in FIG. 8.

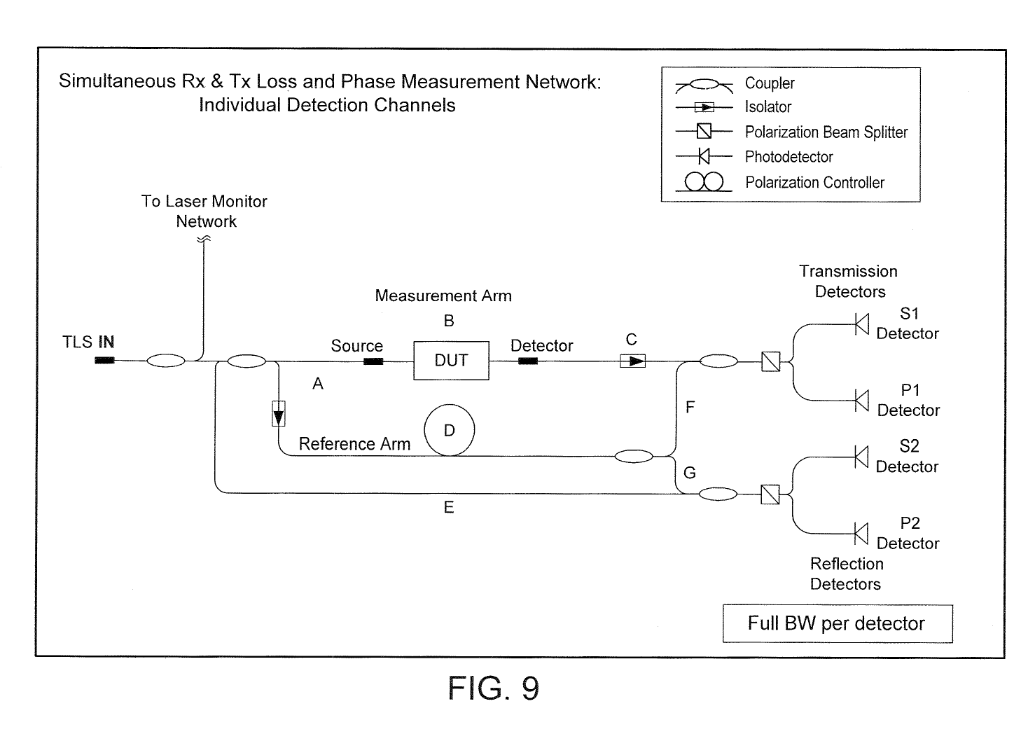

Another example simultaneous Rx and Tx measurement embodiment is shown in FIG. 9 which uses separate optical detectors for simultaneous Rx and Tx measurement. The first set of detectors includes S1 and P1, and the second set of detectors includes S2 and P2. Both Rx and Tx signals are obtained using the same reference path which simplifies build, alignment, and calibration.

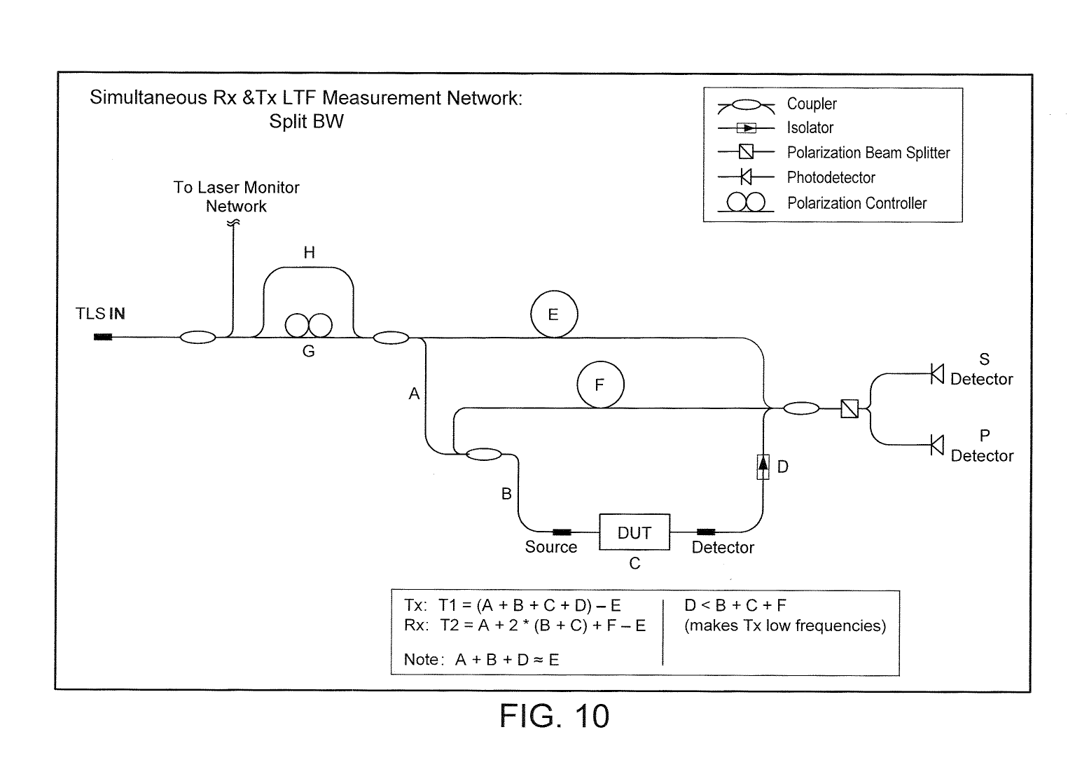

FIG. 10 shows a third example OFDR system that, in a single laser sweep, simultaneously measures the optical transfer function in transmission and reflection and splits the available detection bandwidth between the transmission and reflection “channels.” Another interferometer defined by the path difference between H and G is provided and includes a polarization controller to setup two orthogonal polarization states with which to probe the DUT. These two orthogonal polarization states traverse the reference path E, the reflection measurement path defined by path ABCCBF, and the transmission measurement path defined by path ABCD. As in the FIG. 7 embodiment, the Rx and Tx signals also share the reference and detection optics.

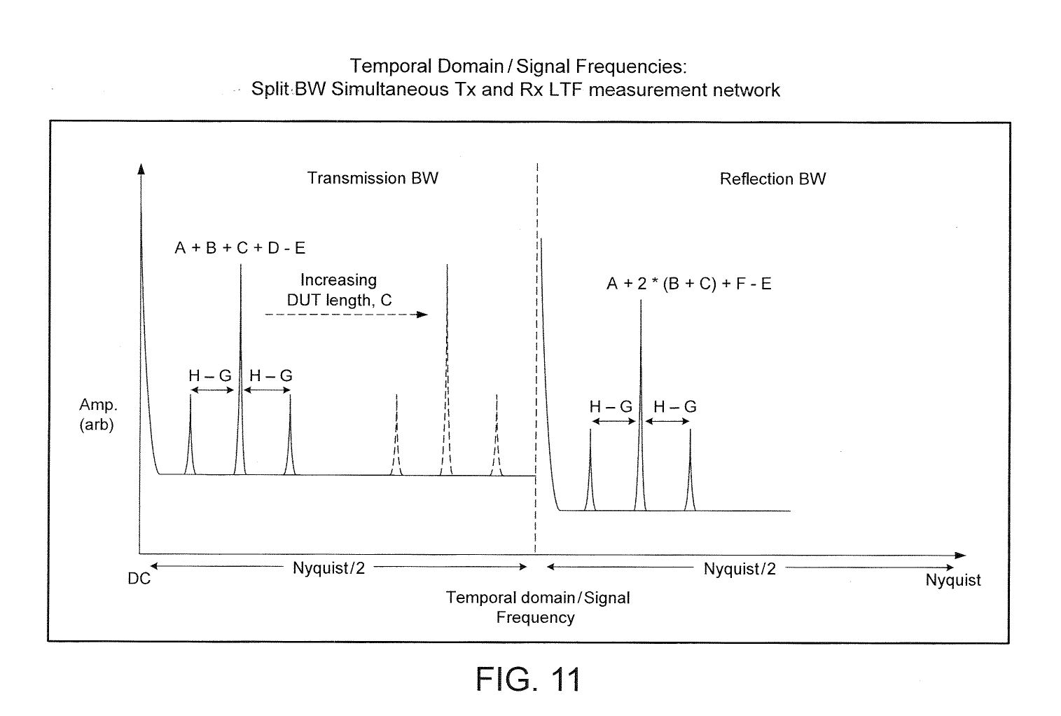

FIG. 11 is a plot the example “split bandwidth” embodiment according to the system in FIG. 10 and shows the Rx and Tx signals occupying half of the available bandwidth. The bandwidths allocated to the Rx and Tx signals can be adjusted by modifying the lengths of A, B, C, D, E, and F accordingly. Again, the isolator is not required, but is used to suppress the signals from the detection optics in the reflection data.

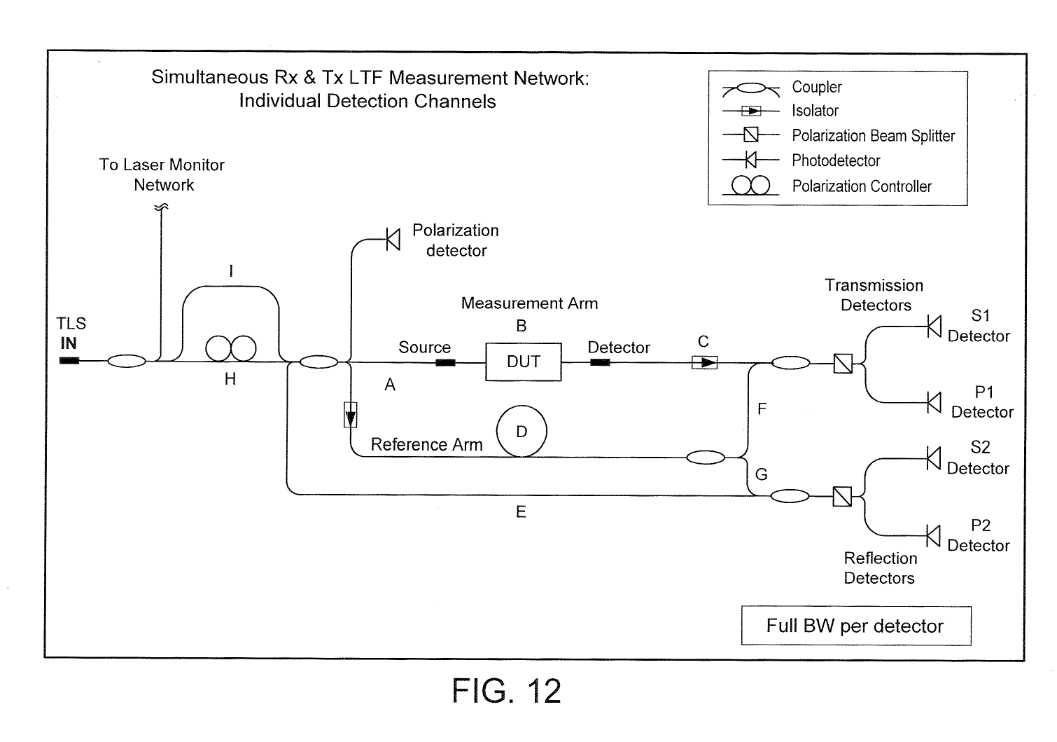

FIG. 12 shows a fourth example OFDR system that, in a single laser sweep, provides simultaneous measurement of the optical transfer function in transmission and reflection but where transmission and reflection OFDR signals use separate detection optical circuitry similar to the embodiment in FIG. 9.

There are relative advantages and disadvantages between split bandwidth and separate detection circuitry embodiments that provide simultaneous measurement of the optical transfer function in transmission and reflection in a single laser sweep. Some relative advantages to splitting bandwidth include: lower hardware cost (optics and analog to digital electronics like filters, amplifiers, etc.), simplified detector response characterization (fewer detectors to characterize, simpler correction implementation), and less overall data. Some relative disadvantages to splitting the detection bandwidth include: smaller useable bandwidth per measurement implies either lower laser sweep speed or shorter maximum device length, and reflection and transmission signals do not have individually optimized electronic gains, so dynamic range may suffer. There are some advantages to separate detectors. For example, full bandwidth per detector implies a longer maximum device length or faster laser sweep speed as the frequency of the resulting interference pattern in an OFDR measurement is directly proportional to both the optical path length of the DUT and the sweep rate of the tunable laser. Because reflection signals are typically smaller than transmission signals, splitting the signals to separate detectors allows for separate optimization of the gains for reflection and transmission signals. Some disadvantages to separate detectors are increased hardware cost associated with more detectors and analog to digital electronics. There are also more detectors to characterize and correct and more data to transfer and process.

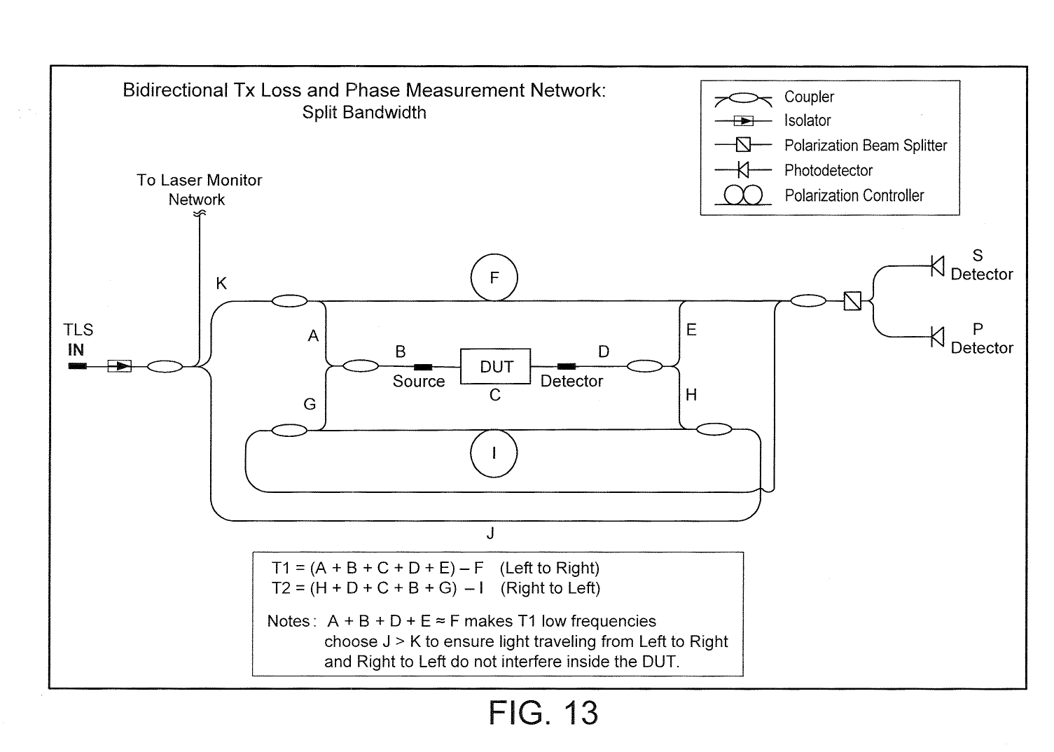

The non-limiting, example OFDR measurement network shown in FIG. 13 enables simultaneous, single sweep, bidirectional loss and phase measurements of an optical device with a single polarization diverse detector. The light that traverses from left to right through path KABCDE interferes with the light that traverses reference path F. The light that travels from right to left through path JHDCBG interferes with the light that traverses reference path I. Setting the sum of paths ABDE approximately equal to path length F ensures the light that travels from left to right is contained in low frequencies. Delay length J in this case is chosen larger than delay length K such that the light that travels from left to right does not interfere with the light that travels from right to left inside the DUT. By implementing a second interferometer that sets up orthogonal polarization states just after the laser input, these networks may be modified to make bidirectional measurements of the device's Linear Transfer Function (LTF).

Massively scalable optical devices such as AWGs, WSSs, TDCs, switches and more are built with higher and higher port counts, e.g., 100 channels per device, with ever diminishing channel spacing. One way to meet this demand is to devise a modular detector card so that more and more photodiodes can be added. But this approach adds cost and complexity because of the additional optics required.

Many optical devices have much smaller port counts such as circulators (3 ports), couplers (up to 3×3), polarization beam splitters (3 ports), single channel add/drop filters (3 ports), phase or amplitude modulators, PLCs, PICs, etc. With these types of devices, space and cost can be reduced by delay division multiplexing numerous measurements into one set of detection optics. The available power and bandwidth per port are reduced as the number of channels increases.

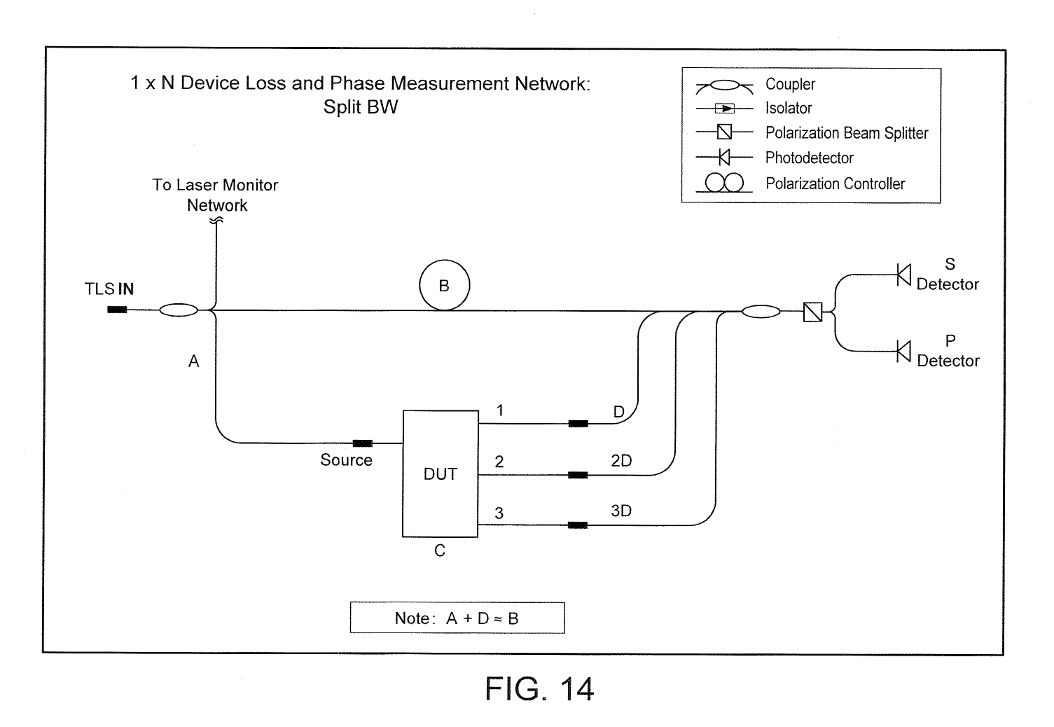

FIG. 14 shows a non-limiting example 1×N OFDR measurement network that measures all transmission paths of the device in a single laser sweep using one polarization diverse receiver. By carefully selecting the delays labeled A through D, each output port of the device can be prescribed a particular bandwidth. There is a trade-off between the number of measurable output ports and the total device length. Since the bandwidth range required to represent the response of a path through the device is dependent on the length of that path, only a finite number of ports can be delay division multiplexed. Further, since the laser light from the tunable laser source is split between ports of the device, less power is available per path as the number of ports increases. By adding a second interferometer on the input, this network may be modified to measure the LTF for each port of the device individually.

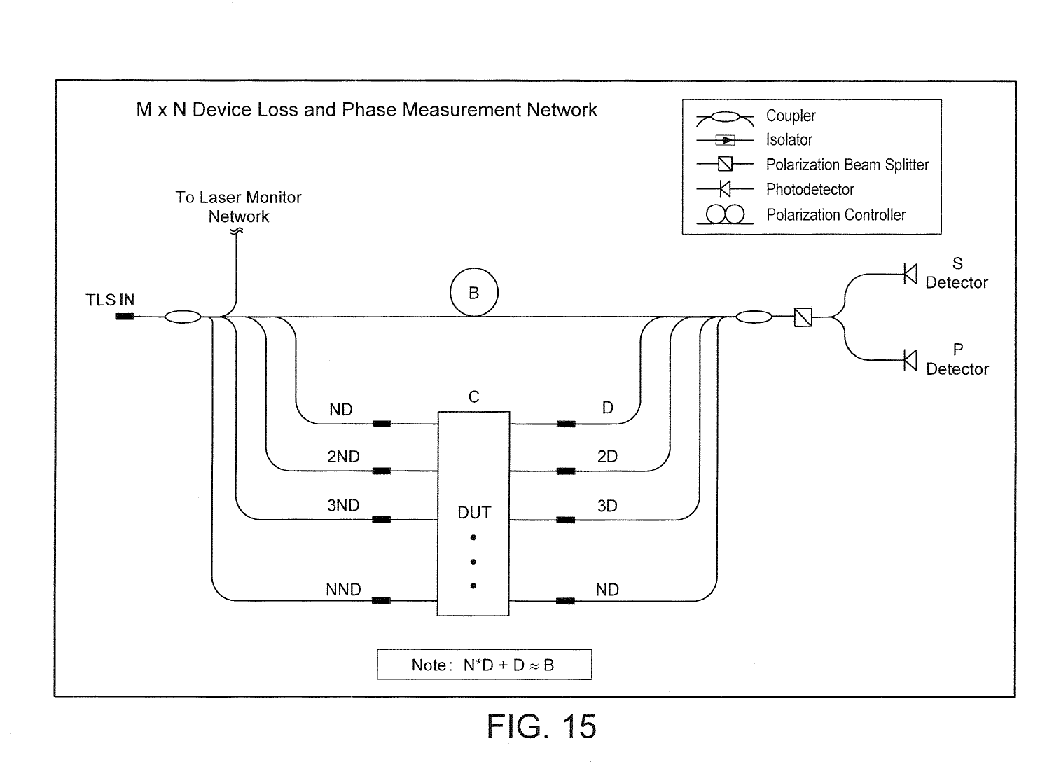

The non-limiting example M×N OFDR transmission network shown in FIG. 15 enables simultaneous measurement of all ports of M×N devices in a single laser sweep. By carefully choosing the delays based on length D, every permutation of paths from input to output of the device can be prescribed a particular bandwidth. This is particularly useful for comparing optical frequency dependent phase, polarization, and amplitude (e.g. crosstalk) between ports. Delays are chosen such that the individual impulse responses for the paths through the DUT appear in reverse order. This is achieved by setting the path length B approximately equal to the product of N and D, where N is the total number of output ports.

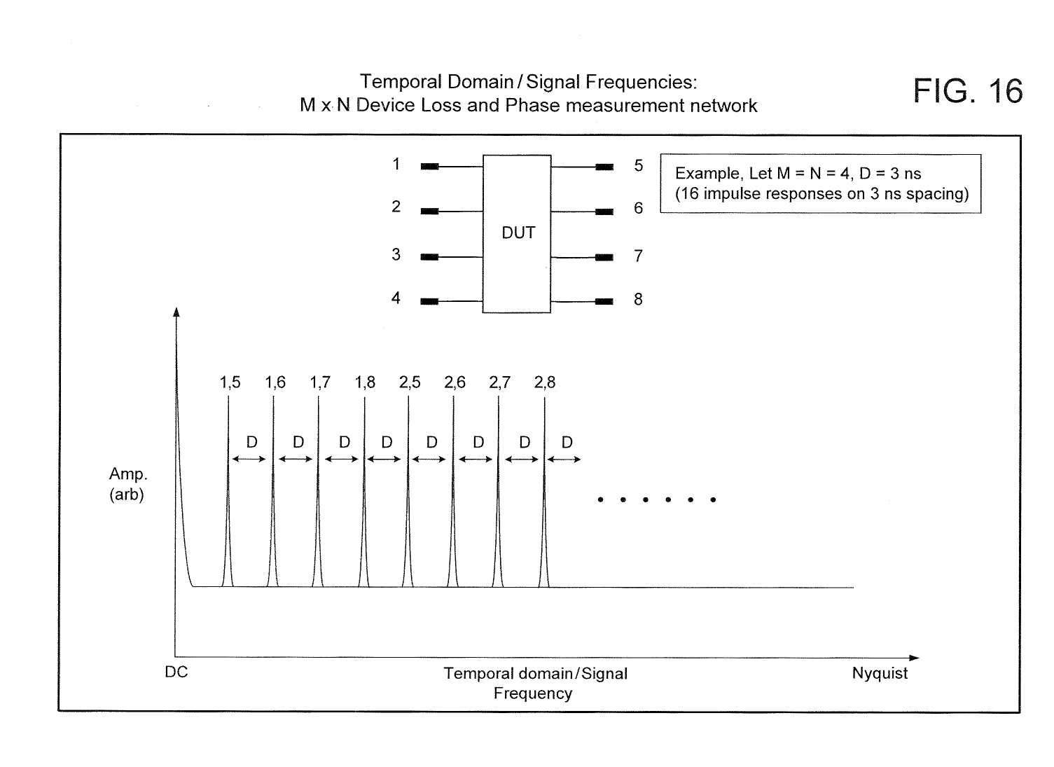

In the example embodiment in FIG. 15, incrementing the input delay by the product of the number of input ports and incrementing the output delays by the length D results in the signal frequencies/temporal domain as illustrated in FIG. 16. The number of measurable ports depends on the expected duration of the impulse response and the available bandwidth in the detection electronics. By adding a second interferometer on the input, this network may be modified to measure the LTF for each permutation of the devices inputs to outputs. Also, separate detector channels could be implemented if more bandwidth is required (for example, longer lengths or faster laser sweep speeds).

Further, each permutation in transmission and reflection in both directions could be measured by including two additional lengths of fiber 1) from the output of the first coupler/splitter to the farside of the second coupler/combiner (inserting light from right to left through the device) and 2) from the input side of the first coupler/splitter to the input side of the second coupler/combiner.

The non-limiting examples disclosed above are chosen for simplicity and illustrative purposes. Further embodiments may be readily generated by those skilled in the art from these examples including an apparatus for simultaneous, bidirectional measurement of the LTF of an M×N device in both transmission and reflection and any permutation of a) simultaneous Tx and Rx measurements of the optical characteristics including but not limited to loss and phase, or the LTF, b) simultaneous multi-directional measurements of optical characteristics, or c) 1×N or M×N port optical measurements.

While the examples described here are interferometric in nature, similar apparatus can be constructed using different optical or electronic hardware. For instance, the swept-tunable laser source may be replaced with a stepped-tunable laser, or a stepped-tunable laser and several frequency modulation units (e.g. electro-optic modulator). Also, optical time domain reflectometry OTDR) could be used rather than OFDR. Further still, similar principles may be employed to interrogate multiple fiber optic sensors (fiber Bragg grating-based systems or Rayleigh-scatter based systems for example) or bulk optic chemical, temperature, strain, pressure, bend, twist, or shape sensors with beneficial savings in ease-of-use, time, bandwidth and cost. Additionally, the polarization diverse detection could be replaced with a single optical detector, or complex receiver.

Although the description above contains many specifics, those specifics should not be construed as limiting but as merely providing illustrations of some presently preferred embodiments. The technology fully encompasses other embodiments which may become apparent to those skilled in the art. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for a device or method to address each and every problem sought to be solved by the described technology for it to be encompassed hereby.

1. Apparatus for performing measurements on an optical device, comprising:
an interrogating laser light source configured to generate light at multiple different wavelengths during a single sweep of the laser light source;
one or more optical interferometric interrogators connected to the interrogating laser light source and connectable to the optical device such that light from the laser is coupled to the optical device and light from the optical device is received by the one or more optical interferometric interrogators in multiple different directions along a number of optical interferometric measurement paths;
optical detection circuitry configured to detect an optical interference pattern, for each of the number of optical interferometric light paths, generated during the single sweep of the interrogating laser light source; and
data processing circuitry configured to determine one or more optical parameters associated with a response determined for each of the number of optical interferometric light paths based on the optical interference pattern detected for each of the number of optical interferometric light paths generated during the single sweep of the interrogating laser.

2. The apparatus in claim 1, wherein the number is greater than or equal to one.

3. The apparatus in claim 1, wherein delays associated with the one or more optical interferometric light paths are selected so that each interference pattern is detected at a unique detection bandwidth.

4. The apparatus in claim 1, wherein the optical detection circuitry includes one set of optical detectors configured to detect the optical interference patterns for each of the optical interferometric light paths generated during the single sweep of the interrogating laser light source.

5. The apparatus in claim 4, wherein the one set of optical detectors is configured to detect, using a first portion of available detection bandwidth, the optical interference patterns for optical interferometric light transmission paths generated during the single sweep of the interrogating laser light source, and to detect, using a second different portion of the available detection bandwidth, the optical interference patterns for optical interferometric light reflection paths generated during the single sweep of the interrogating laser light source.

6. The apparatus in claim 1, wherein the optical detection circuitry includes multiple sets of optical detectors configured to detect the optical interference patterns for each of the optical interferometric light paths generated during the single sweep of the interrogating laser light source.

7. The apparatus in claim 6, wherein each of the multiple sets of optical detectors is configured to detect, using an available detection bandwidth, the optical interference patterns for optical interferometric light transmission paths generated during the single sweep of the interrogating laser light source, and to detect, using substantially the same available detection bandwidth, the optical interference patterns for optical interferometric light reflection paths generated during the single sweep of the interrogating laser light source.

8. The apparatus in claim 1, wherein the one or more optical interferometric interrogators include a measurement optical interferometric interrogator and a laser monitor optical interferometric interrogator.

9. The apparatus in claim 8, wherein the one or more optical interferometric interrogators include another optical interferometric interrogator that includes a polarization controller configured to provide light with orthogonal polarization states for probing the optical device.

10. The apparatus in claim 1, wherein the data processing circuitry is configured to measure a Linear Transfer Function for each path through the device.

11. The apparatus in claim 1, wherein the one or more optical parameters include one or more of insertion loss (IL), phase, group delay (GD), chromatic dispersion (CD), polarization mode dispersion (PMD), second order polarization mode dispersion (SOPMD), differential group delay (DGD), or polarization dependent loss (PDL).

12. The apparatus in claim 1, wherein the determined one or more optical parameters fully optically characterize the optical device through all light propagation paths including all permutations of optical device input ports and optical device output ports.

13. A method for performing measurements on an optical device, comprising:
generating, during a single sweep of a laser light source, light at multiple different wavelengths;
guiding light from the laser, via one or more optical interferometric interrogators, to the optical device in multiple different directions along a number of optical interferometric measurement paths;
receiving light from the optical device in multiple different directions along the number of optical interferometric measurement paths by the one or more optical interferometric interrogators;
detect an optical interference pattern, for each of the number of optical interferometric light paths, generated during the single sweep of the interrogating laser light source; and
determining one or more optical parameters associated with a response determined for each of the number of optical interferometric light paths based on the optical interference pattern detected for each of the number of optical interferometric light paths generated during the single sweep of the interrogating laser.

14. The method in claim 13, further comprising:
determining a maximum number of optical paths through the optical device including transmission paths, reflection paths, permutations of light coupling from input to input ports, input to output ports, output to input ports, and output to output ports.

15. The method in claim 14, further comprising:
determining a minimum number of reference paths for the one or more optical interferometric interrogators.

16. The method in claim 15, further comprising:
determining optical path lengths that provide delay domain separation for each optical path through the optical device as compared with reference path optical delays and available detection bandwidth.

17. The method in claim 13, wherein the number is greater than or equal to one.

18. The method in claim 13, wherein delays associated with the one or more optical interferometric light paths are selected so that each interference pattern is detected at a unique detection bandwidth.

19. The method in claim 13, wherein the one or more optical parameters include one or more of insertion loss (IL), phase, group delay (GD), chromatic dispersion (CD), polarization mode dispersion (PMD), second order polarization mode dispersion (SOPMD), differential group delay (DGD), or polarization dependent loss (PDL).

20. The method in claim 13, wherein the determined one or more optical parameters fully optically characterize the optical device through all light propagation paths including all permutations of optical device input ports and optical device output ports.

21. The method in claim 13, further comprising measuring a Linear Transfer Function for each path through the device.
